(19) United States
(12) Patent Application Publication
(10) Pub. No.: US 2002/0147256 A1
(43) Pub. Date: Oct. 10, 2002

(54) Flame-resistant polycarbonate compositions

(76) Inventors: Thomas Eckel, Dormagen (DE); Nikolaus Janke, Dormagen (DE); Uwe Peucker, Meerbusch (DE); Andreas Seidel, Dormagen (DE); Dieter Wittmann, Leverkusen (DE)

Correspondence Address: BAYER CORPORATION, PATENT DEPARTMENT, 100 BAYER ROAD, PITTSBURGH, PA, 15205, US

(21) Appl. No.: 09/911,268

(22) Filed: Jul. 23, 2001

(30) Foreign Application Priority Data
Jul. 25, 2000 (DE) 100 36 057.2

(51) Int. Cl. C08K 5/49

(52) U.S. Cl. 524/115

(57) ABSTRACT

The invention relates to flame-resistant polycarbonate compositions comprising a phosphorus compound of the general formula (I),

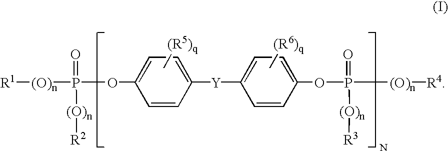

With reference to general formula (I): R¹, R², R³ and R⁴ are each independently selected from (i) C₁ to C₈ alkyl optionally substituted by halogen, (ii) C₅ to C₆ cycloalkyl, (iii) C₆ to C₁₀ aryl and (iv) C₇ to C₁₂ aralkyl, each of (ii)-(iv) being optionally and independently substituted by at least one of halogen and C₁ to C₄ alkyl; n is 0 or 1; q is 0, 1, 2, 3 or 4; N is 0.1 to 5; R⁵ and R⁶ are each independently selected from C₁ to C₄ alkyl and halogen; and Y denotes isopropylidene. The phosphorous compound represented by general formula (I) comprises less than 1 wt. % of isopropenylphenyl phosphate, based on the weight of the phosphorous compound represented by general formula (I).

### CROSS REFERENCE TO RELATED PATENT APPLICATIONS

The present patent application claims priority under 35 U.S.C. 119 (a)-(d) of German Patent Application Serial No. 100 36 057.2, filed on Jul. 25, 2000.

### FIELD OF THE INVENTION

The present invention relates to flame-resistant polycarbonate compositions containing phosphorous compounds, and mouldings produced therefrom.

### BACKGROUND OF THE INVENTION

The use of diphosphates as flame retardants for polycarbonate compositions is known and is described for example in EP-A 0 363 608, EP-A 0 771 851 and EP-A 0 755 977. A problem with the use of diphosphates as flame retardants is the associated impairment of the mechanical properties of the polycarbonate. In order to achieve a balanced property profile, as a rule further additives typically have to be added.

For specific applications that require a particularly high hydrolysis stability or that are expected to form particularly small amounts of tool coating on account of the tool design, oligophosphates based on bisphenol A are used as flame retardants.

From WO 99/07792 flame resistant polycarbonate-ABS compositions are known that contain an additive combination comprising an oligophosphate based on bisphenol A as well as a synergistically acting amount of one or more very finely particulate inorganic materials, in order to improve the stress cracking resistance, notched impact strength and heat resistance.

From DE-A 198 53 105 flame-resistant polycarbonate compositions modified with graft polymers are also known, which contain oligophosphates based on bisphenol A and special graft polymers obtained by bulk polymerisation in order to improve the mechanical properties.

The disadvantage of these polycarbonate compositions is in particular the fact that the mouldings produced therefrom suffer an increasing deterioration in mechanical properties under prolonged thermal stress. Moreover they tend to undergo yellowing during heat aging, which is undesirable for both application technology and aesthetic reasons.

### SUMMARY OF THE INVENTION

The object of the invention is to provide flame-retardant polycarbonate compositions that have, in addition to good mechanical properties and high heat resistance, also a significantly improved long-term behavior (maintenance of properties under thermal stress).

It has now been found that polycarbonate compositions that contain special phosphorus compounds with a small content of isopropenylphenyl phosphate, i.e. less than 1 wt. % referred to the phosphorus compound that is employed, exhibit the desired property profile.

Other than in the operating examples, or where otherwise indicated, all numbers expressing quantities of ingredients, reaction conditions, and so forth used in the specification and claims are to be understood as modified in all instances by the term “about.”

### DETAILED DESCRIPTION OF THE INVENTION

Commercially available oligophosphates based on bisphenol A contain isopropenyl-phenyl phosphate (IPP) as an impurity in an amount of up to about 10 wt. %. This impurity is formed as a breakdown product in the synthesis of the aforementioned oligophosphates, especially at high temperatures and long reactor residence times. In addition the breakdown product may also be formed as a result of incorrect transportation and/or storage.

It has now surprisingly been found that isopropenylphenyl phosphate contained as an impurity in commercially obtainable oligophosphates based on bisphenol A has an undesirable effect on the properties of the polycarbonates and/or polyester carbonates provided with oligophosphates as flame retardants. Too high a IPP content has in particular an undesirable effect on the burning time, measured according to UL 94, as well as on the heat resistance. Furthermore too high a IPP content leads under prolonged thermal stress or heat ageing, which may arise in certain applications, for example 1500 hours at 60° C. or 500 hours at 80° C., to a yellowing of the polycarbonate compositions and/or to a deterioration in mechanical properties.

These disadvantages are avoided according to the invention if the IPP content of the oligophosphate used as flame retardant is restricted to less than 1 wt. %. Polycarbonates or polyester carbonates provided with such a flame retardant have an improved heat resistance, an improved afterburning behaviour, and a reduced tendency to yellowing under heat ageing.

The invention accordingly provides polycarbonate compositions, in particular thermoplastic polycarbonate compositions, containing phosphorus compounds represented by the following general formula (I),

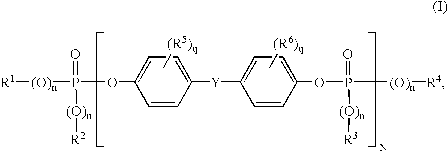

in which

R¹, R², R³ and R⁴ are each independently selected from (i) C₁ to C₈ alkyl optionally substituted by halogen, (ii) C₅ to C₆ cycloalkyl, (iii) C₆ to C₁₀ aryl and (iv) C₇ to C₁₂ aralkyl, each of (ii), (iii) and (iv) being optionally and independently substituted by at least one of halogen and C₁ to C₄ alkyl;

n is 0 or 1;

q is 0, 1, 2, 3 or 4;

N is 0.1 to 5, preferably 0.9 to 2.5, in particular 1 to 1.5;

R⁵ and R⁶ are each independently selected from C₁ to C₄ alkyl (preferably methyl) and halogen (preferably chlorine and/or bromine);

Y denotes isopropylidene; and

wherein the phosphorous compound represented by general formula (I) comprises less than 1 wt. % of isopropenylphenyl phosphate, preferably less than 0.5 wt. %, particularly preferably less than 0.2 wt. %, based on the weight of the phosphorus compound represented by general formula (I).

In a particularly preferred embodiment of the present invention, the phosphorous compound represented by general formula (I) comprises 0 wt. % of isopropenylphenyl phosphate, based on the weight of the phosphorus compound represented by general formula (I).

As used herein and in the claims the phrase “the phosphorous compound represented by general formula (I)” and similar phrases refers to single phosphorous compounds or mixtures of phosphorous compounds represented by general formula (I). Preferably the compositions of the present invention contain 0.5 to 20 wt. %, particularly preferably 1 to 18 wt. %, and especially 2 to 16 wt. % of phosphorus compound (I) or a mixture of phosphorus compounds (I), based on the total weight of the composition.

In a preferred embodiment of the present invention, the composition comprises:

A) 40 to 99 wt. %, preferably 50 to 95 wt. %, in particular 60 to 90 wt. % of aromatic polycarbonate and/or polyester carbonate;

B) 0.5 to 60 wt. %, preferably 0.8 to 40 wt. %, in particular 1 to 30 wt. % of a graft polymer

C) 0 to 45 wt. % of at least one thermoplastic polymer selected from vinyl (co)polymers and polyalkylene terephthalates,

D) 0.5 to 20 wt. % of a phosphorus compound represented by the general formula (I), as described previously herein; and

E) 0 to 5 wt. % of a fluorinated polyolefin; the weight percents of A), B), C), D) and E) are each based on the total weight of said composition.

Components A (aromatic polycarbonate and/or aromatic polyester carbonates), B (graft polymer), C (thermoplastic polymer), D (phosphorus compound represented by general formula I), and E (fluorinated polyolefins) suitable for producing the compositions according to the invention are described in more detail hereinafter.

Component A

Suitable aromatic polycarbonates and/or aromatic polyester carbonates, i.e. component A, according to the invention are known in the literature or can be produced by processes known in the literature (for the production of aromatic polycarbonates see for example Schnell, “Chemistry and Physics of Polycarbonates”, Interscience Publishers, 1964 as well as DE-A 14 95 626, DE-A 22 32 877, DE-A 27 03 376, DE-A 27 14 544, DE-A 30 00 610, DE-A 38 32 396; for the production of aromatic polyester carbonates see for example DE-A 30 77 934.

The production of aromatic polycarbonates is effected for example by reacting diphenols with carbonic acid halides, preferably phosgene, and/or with aromatic dicarboxylic acid halides, preferably benzenedicarboxylic acid dihalides, according to the phase interface process, optionally using chain terminators, for example monophenols, and optionally using trifunctional or higher functionality branching agents, for example triphenols or tetraphenols.

Diphenols used for the production of the aromatic polycarbonates and/or aromatic polyester carbonates are preferably those represented by the following formula (II),

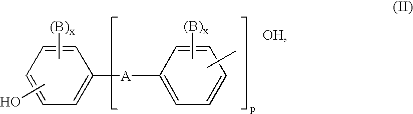

wherein

A denotes a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, onto which further aromatic rings optionally containing heteroatoms may be condensed,

or a radical represented by the following formulas (III) or (IV)

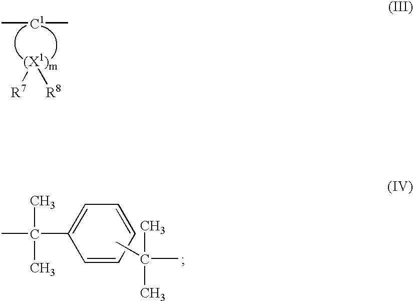

B denotes in each case C₁ to C₁₂ alkyl, preferably methyl, halogen, preferably chlorine and/or bromine;

x is in each case 0, 1 or 2;

p is 0 or 1;

R⁷ and R⁸ which may be selected individually for each X¹, denote independently of one another hydrogen or C₁ to C₆ alkyl, preferably hydrogen, methyl or ethyl,

X¹ is carbon; and

m is an integer from 4 to 7, preferably 4 or 5, with the proviso that on at least one atom, X¹, R⁷ and R⁸ are simultaneously C₁ to C₆ alkyl.

Preferred diphenols are hydroquinone, resorcinol, dihydroxydiphenols, bis-(hydroxyphenyl)-C₁-C₅ alkanes, bis-(hydroxyphenyl)-C₅-C₆ cycloalkanes, bis-(hydroxyphenyl)-ethers, bis-(hydroxyphenyl)-sulfoxides, bis-(hydroxyphenyl)-ketones, bis-(hydroxyphenyl)-sulfones and α,α-bis-(hydroxyphenyl)-diisopropylbenzenes, as well as their nuclear-brominated (i.e., the aromatic ring(s) are substituted with at least one bromine atom) and/or nuclear-chlorinated derivatives.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenylsulfide, 4,4′-dihydroxydiphenylsulfone as well as their dibrominated and tetrabrominated or chlorinated derivatives such as for example 2,2-bis(3-chloro-4-hydroxyphenyl)-propane, 2,2-bis(3,5-dichloro-4-hydroxyphenyl)-propane or 2,2-bis(3,5-dibromo-4-hydroxyphenyl)-propane.

2,2-bis(4-hydroxyphenyl)-propane (bisphenol A) is particularly preferred.

The diphenols may be used individually or as arbitrary mixtures, and are known in the literature or can be obtained by processes known in the literature.

Suitable chain terminators for the production of the thermoplastic aromatic polycarbonates are for example phenol, p-chlorophenol, p-tert.-butylphenol or 2,4,6-tribromophenol, but also long-chain alkylphenols, such as 4-(1,3-tetramethylbutyl)-phenol according to DE-A 28 42 005 or monoalkylphenol and/or dialkylphenols having a total of 8 to 20 C atoms in the alkyl substituents, such as 3,5-di-tert.-butylphenol, p-iso-octylphenol, p-tert.-octylphenol, p-dodecylphenol, 2-(3,5-dimethylheptyl)-phenol and 4-(3,5-dimethylheptyl)-phenol. The amount of chain terminators to be used is in general between 0.5 mole % and 10 mole %, referred to the molar sum of the diphenols used in each case.

The thermoplastic aromatic polycarbonates have average (weight average) molecular weights M_{w}, measured for example by ultracentrifugation or light scattering, of 10,000 to 200,000, preferably 20,000 to 80,000.

The thermoplastic aromatic polycarbonates may be branched in a manner known per se, and more specifically preferably by the incorporation of 0.05 to 2.0 mole %, referred to the total amount of diphenols employed, of trifunctional or higher functionality compounds, for example those with three or more phenolic groups.

Homopolycarbonates as well as copolycarbonates are suitable. In order to produce copolycarbonates (component A) to be used according to the invention, there may also be used 1 to 25 wt. %, preferably 2.5 to 25 wt. %, referred to the total amount of diphenols used, of polydiorganosiloxanes with hydroxy-aryloxy terminal groups. These are known for example from U.S. Pat. No. 3,419,634 or may be prepared by processes known in the literature. The production of copolycarbonates containing poly-diorganosiloxane is described for example in DE 33 34 782.

Preferred polycarbonates are, in addition to the bisphenol A homopolycarbonates, also the copolycarbonates of bisphenol A with up to 15 mole %, referred to the molar sum of diphenol, of other diphenols mentioned as preferred or particularly preferred, in particular 2,2-bis(3,5-dibromo-4-hydroxyphenyl)-propane.

Aromatic dicarboxylic acid dihalides for the production of aromatic polyester carbonates are preferably the diacid dichlorides of isophthalic acid, terephthalic acid, diphenylether-4,4′-dicarboxylic acid and of naphthalene-2,6-dicarboxylic acid.

Particularly preferred are mixtures of the diacid dichlorides of isophthalic acid and terephthalic acid in a ratio between 1:20 and 20:1.

In the production of polyester carbonates a carbonic acid halide, preferably phosgene, is co-used in addition as bifunctional acid derivative.

Suitable chain terminators for the production of the aromatic polyester carbonates include, apart from the already mentioned monophenols, also their chlorocarbonic acid esters as well as the acid chlorides of monocarboxylic acids, which may optionally be substituted by C₁ to C₂₂ alkyl groups or by halogen atoms, as well as aliphatic C₂ to C₂₂ monocarboxylic acid chlorides.

The amount of chain terminators is preferably in each case 0.1 to 10 mole %, referred in the case of phenolic chain terminators to each mole of diphenol, and in the case of monocarboxylic acid chloride chain terminators to each mole of dicarboxylic acid dichloride.

The aromatic polyester carbonates may also contain incorporated aromatic hydroxycarboxylic acids.

The aromatic polyester carbonates may be linear as well as branched in a manner known per se, in which connection reference should be made to the disclosures in DE-A 29 40 024 and DE-A 30 07 934.

As branching agents there may be used for example 3-functional or higher functionality carboxylic acid chlorides such as trimesic acid trichloride, cyanuric acid trichloride, 3,3′-4,4′-benzophenonetetracarboxylic acid tetrachloride, 1,4,5,8-napthalenetetracarboxylic acid tetrachloride or pyromellitic acid tetrachloride, in amounts of 0.01 to 1.0 mole % (referred to dicarboxylic acid dichlorides that are used), or 3-functional or higher functionality phenols such as phloroglucinol, 4,6-dimethyl-2,4,6-tri-(4-hydroxyphenyl)-hept-2-ene, 4,4-dimethyl-2,4-6-tri(4-hydroxy-phenyl)-heptane, 1,3,5-tri-(4-hydroxyphenyl)-benzene, 1,1,1-tri-(4-hydroxy-phenyl)-ethane, tri-(4-hydroxyphenyl)-phenylmethane, 2,2-bis[4,4-bis(4-hydroxyphenyl)-cyclohexyl]-propane, 2,4-bis-(4-hydroxyphenylisopropyl)-phenol, tetra-(4-hydroxy-phenyl)-methane, 2,6-bis-(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-iso-propyl]-phenoxy)-methane, 1,4-bis[4,4′-dihydroxytriphenyl)-methyl]-benzene, in amounts of 0.01 to 1.0 mole %, referred to the diphenol used. Phenolic branching agents may be added together with the diphenols, while acid chloride branching agents may be added together with the acid dichlorides.

The proportion of carbonate structural units may be varied as desired in the thermoplastic aromatic polyester carbonates. The proportion of carbonate groups is preferably up to 100 mole %, in particular up 80 mole %, particularly preferably up to 50 mole %, referred to the sum of ester groups and carbonate groups. Both the ester fraction and also the carbonate fraction of the aromatic polyester carbonates may be present in the form of blocks or statistically distributed in the polycondensate.

The relative solution viscosity (η_{rel.}) of the aromatic polycarbonates and polyester carbonates is 1.18 to 1.4, preferably 1.2 to 1.3, measured in solutions of 0.5 g of polycarbonate or polyester carbonate in 100 ml of methylene chloride at 25° C.

The thermoplastic aromatic polycarbonates and polyester carbonates may be used alone or in mixtures with one another.

Component B

Graft polymers B that may be used according to the invention include for example graft copolymers having rubber-elastic properties, which can in principle be obtained from at least two of the following monomers: chloroprene, butadiene-1,3, isoprene, styrene, acrylonitrile, ethylene, propylene, vinyl acetate and (meth)acrylic acid esters with 1 to 18 C atoms in the alcohol component, i.e. polymers such as are described for example in “Methoden der Organischen Chemie” (Houben-Weyl), Vol. 14/1, Georg Thieme-Verlag, Stuttgart 1961, pp. 393-406 and in C. B. Bucknall “Toughened Plastics”, Appl. Science Publishers, London 1977. Preferred polymers C are partially crosslinked and have gel contents of above 20 wt. %, preferably above 40 wt. %, and in particular above 60 wt. %.

In particular the component B comprises one or more graft polymers prepared from:

B.1 5 to 95 wt. %, preferably 30 to 90 wt. %, of at least one vinyl monomer; and

B.2 95 to 5 wt. %, preferably 70 to 10 wt. % of one or more graft bases with glass transition temperatures of <(i.e., “less than”) 1° C., preferably <0° C., and particularly preferably <−20° C.

The graft base B.2 generally has a mean particle size (d₅₀ value) of 0.05 to 5 μm, preferably 0.10 to 0.6 μm, particularly preferably 0.1 to 0.5 μm, and most particularly preferably 0.20 to 0.40 μm.

Monomers B.1 are preferably mixtures of:

B.1.1 50 to 99 parts by weight of vinyl aromatic compounds and/or nuclear-substituted vinyl aromatic compounds (for example styrene, α-methylstyrene, p-methylstyrene, p-chlorostyrene) and/or (meth)acrylic acid-(C₁ to C₈)-alkyl esters (such as methyl methacrylate, ethyl methacrylate); and

B.1.2 1 to 50 parts by weight of vinyl cyanides (unsaturated nitriles such as acrylonitrile and methacrlyonitrile) and/or (meth)acrylic acid-(C₁ to C₈)-alkyl esters (such as methyl methacrylate, n-butyl acrylate, t-butyl acrylate) and/or derivatives (such as anhydrides and imides) of unsaturated carboxylic acids (for example maleic acid anhydride and N-phenylmaleimide).

Preferred monomers B.1.1 are selected from at least one of the monomers styrene, α-methylstyrene and methyl methacrylate, and preferred monomers B.1.2 are selected from at least one of the monomers acrylonitrile, maleic acid anhydride and methyl methacrylate.

Particularly preferred monomers are styrene (B.1.1) and acrylonitrile (B1.2).

Suitable graft bases B.2 for the graft polymers B are for example diene rubbers, EP(D)M rubbers, i.e. those based on ethylene/propylene and optionally diene, as well as acrylate, polyurethane, silicone, chloroprene and ethylene/vinyl acetate rubbers.

Preferred graft bases B.2 are diene rubbers (for example based on butadiene, isoprene etc.) or mixtures of diene rubbers or copolymers of diene rubbers or their mixtures with further copolymerisable monomers (e.g. according to B.1.1 and B.1.2), with the proviso that the glass transition temperature of the component B.2 is <10° C., preferably <0° C., and particularly preferably <−10° C.

Pure polybutadiene rubber is particularly preferred.

Particularly preferred polymers B include for example ABS polymers (emulsion, bulk and suspension ABS), such as are described for example in DE-A 20 35 390 or DE-A 22 48 242, or in Ullmann, Enzyklopädie der Technischen Chemie, Vol. 19 (1980), p.280 et seq. The gel content of the graft base B.2 is preferably at least 30 wt. %, preferably at least 40 wt. % (measured in toluene).

The graft copolymers B are produced by free radical polymerisation, for example by emulsion, suspension, solution or bulk polymerisation, and preferably by emulsion polymerisation or bulk polymerisation.

Particularly suitable graft rubbers are also ABS polymers that are produced by redox initiation with an initiator system consisting of an organic hydroperoxide, cumene hydroperoxide or t-butyl hydroperoxide and ascorbic acid, according to U.S. Pat. No. 4,937,285.

Since in the graft reaction the graft monomers are, as is known, not necessarily completely grafted onto the graft base, according to the invention graft polymers B are also understood to include those products that are obtained by (co)polymerisation of the graft monomers in the presence of the graft base and that are present in the working-up stage.

Suitable acrylate rubbers according to B.2 of the polymers B are preferably polymers of acrylic acid alkyl esters, optionally with up to 40 wt. %, referred to B.2, of other polymerisable, ethylenically unsaturated monomers. The preferred polymerisable acrylic acid esters include C₁ to C₈ alkyl esters, for example methyl, ethyl, butyl, n-octyl and 2-ethylhexyl esters; halogenated alkyl esters, preferably halogen-C₁-C₈-alkyl esters such as chloroethyl acrylate, as well as mixtures of these monomers.

For the crosslinking, monomers with more than one polymerisable double bond may be copolymerised. Preferred examples of crosslinking monomers are esters of unsaturated monocarboxylic acids with 3 to 8 C atoms and unsaturated monohydric alcohols with 3 to 12 C atoms, or saturated polyols with 2 to 4 OH groups and 2 to 20 C atoms, such as ethylene glycol dimethacrylate, allyl methacrylate; multiply unsaturated heterocyclic compounds such as trivinyl cyanurate and triallyl cyanurate; polyfunctional vinyl compounds such as divinylbenzenes and trivinylbenzenes; and also triallyl phosphate and diallyl phthalate.

Preferred crosslinking monomers are allyl methacrylate, ethylene glycol dimethacrylate, diallyl phthalate and heterocyclic compounds containing at least three ethylenically unsaturated groups.

Particularly preferred crosslinking monomers are the cyclic monomers triallyl cyanurate, triallyl isocyanurate, triacrylohexahydro-s-triazine, triallylbenzenes. The amount of the crosslinking monomers is preferably 0.02 to 5 wt. %, in particular 0.05 to 2 wt. %, referred to the graft base B.2.

With cyclic crosslinking monomers having at least three ethylenically unsaturated groups it is advantageous to restrict the amount to less than 1 wt. % of the graft base B.2.

Preferred “other” polymerisable, ethylenically unsaturated monomers that may optionally serve, in addition to the acrylic acid esters, for the production of the graft base B.2 include for example acrylonitrile, styrene, α-methylstyrene, acrylamides, vinyl-C₁-C₆-alkyl ethers, methyl methacrylate and butadiene. Preferred acrylate rubbers as graft base B.2 are emulsion polymers with a gel content of at least 60 wt. %.

Further suitable graft bases according to B.2 include silicone rubbers with graft-active sites, such as are described in DE-A 37 04 657, DE-A 37 04 655, DE-A 36 31 540 and DE-A 36 31 539.

The gel content of the graft base B.2 is determined at 25° C. in a suitable solvent (M. Hoffmann, H. Krömer, R. Kuhn, Polymeranalytik I and II, Georg Thieme-Verlag, Stuttgart 1977).

The mean particle size d₅₀ is the diameter above and below which in each case 50 wt. % of the particles lie, and may be determined by ultracentrifugation measurements (W. Scholtan, H. Lange, Kolloid, Z. and Z. Polymere 250 (1972), 782-1796).

Component C

The component C comprises one or more thermoplastic vinyl (co)polymers C.1 and/or polyalkylene terephthalates C.2.

Suitable as vinyl (co)polymers C.1 are polymers obtained from at least one monomer from the group comprising vinyl aromatic compounds, vinyl cyanides (unsaturated nitrites), (meth)acrylic acid-(C₁ to C₈)-alkyl esters, unsaturated carboxylic acids, as well as derivatives (such as anhydrides and imides) of unsaturated carboxylic acids. Particularly suitable are (co)polymers of:

C.1.1 50 to 99 wt. %, preferably 60 to 80 wt. % of vinyl aromatic compounds and/or nuclear substituted vinyl aromatic compounds such as for example styrene, α-methylstyrene, p-methylstyrene, p-chlorostyrene) and/or (meth)acrylic acid-(C₁ to C₈)-alkyl esters such as for example methyl methacrylate, ethyl methacrylate, and

C.1.2 1 to 50 wt. %, preferably 20 to 40 wt. % of vinyl cyanides (unsaturated nitrites) such as acrylonitrile and methacrylonitrile and/or (meth)acrylic acid-(C₁ to C₈)-alkyl esters (such as methyl methacrylate, n-butyl acrylate, t-butyl acrylate) and/or unsaturated carboxylic acids (such as maleic acid) and/or derivatives (such as anhydrides and imides) of unsaturated carboxylic acids (for example maleic anhydride and N-phenylmaleimide).

The (co)polymers C.1 are resin-like, thermoplastic and rubber-free.

The copolymer formed from styrene (C.1.1) and acrylonitrile (C.1.2) is particularly preferred.

The (co)polymers according to C.1 are known and can be produced by free radical polymerisation, in particular by emulsion, suspension, solution or bulk polymerisation. The (co)polymers preferably have molecular weights M_{w} (weight average molecular weight determined by light scattering or sedimentation) of between 15,000 and 200,000.

The polyalkylene terephthalates of the component C.2 are reaction products of aromatic dicarboxylic acids or their reactive derivatives, such as dimethyl esters or anhydrides, and aliphatic, cycloaliphatic or araliphatic diols, as well as mixtures of these reaction products.

Preferred polyalkylene terephthalates contain at least 80 wt. %, preferably at least 90 wt. %, referred to the dicarboxylic acid component, of terephthalic acid radicals, and at least 80 wt. %, preferably at least 90 wt. %, referred to the diol component, of ethylene glycol radicals and/or butanediol-1,4 radicals.

The preferred polyalkylene terephthalates may contain, in addition to terephthalic acid esters, up to 20 mole %, preferably up to 10 mole %, of radicals of other aromatic or cycloaliphatic dicarboxylic acids with 8 to 14 C atoms or aliphatic dicarboxylic acids with 4 to 12 C atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid and cyclohexanediacetic acid.

The preferred polyalkylene terephthalates may contain, in addition to ethylene glycol radicals and/or butanediol-1,4 radicals, up to 20 mole %, preferably up to 10 mole %, of other aliphatic diols with 3 to 12 C atoms or cycloaliphatic diols with 6 to 21 C atoms, for example radicals of propanediol-1,3,2-ethylpropanediol-1,3, neopentyl glycol, pentanediol-1,5, hexanediol-1,6, cyclohexanedimethanol-1,4, 3-ethylpentanediol-2,4,2-methylpentanediol-2,4, 2,2,4-trimethylpentanediol-1,3,2-ethylhexanediol-1,3,2,2-diethylpropanediol-1,3, hexanediol-2,5, 1,4-di-(β-hydroxyethoxy)-benzene, 2,2-bis-(4-hydroxycyclohexyl)-propane, 2,4-dihydroxy-1,1,3,3-tetramethylcyclobutane, 2,2-bis-(4-p-hydroxyethoxyphenyl)-propane and 2,2-bis-(4-hydroxypropoxyphenyl)-propane (DE-A 24 07 674, DE-A 24 07 776, DE-A 27 15 932).

The polyalkylene terephthalates may be branched by incorporating relatively small amounts of trihydric or tetrahydric alcohols or tribasic or tetrabasic carboxylic acids, for example according to DE-A 19 00 270 and U.S. Pat. No. 3,692,744. Examples of preferred branching agents include trimesic acid, trimellitic acid, trimethylolethane and trimethylolpropane, and pentaerythritol.

Particularly preferred are polyalkylene terephthalates that have been produced solely from terephthalic acid and its reactive derivatives (for example its dialkyl esters) and ethylene glycol and/or butanediol-1,4, and mixtures of these polyalkylene terephthalates.

Mixtures of polyalkylene terephthalates contain 1 to 50 wt. %, preferably 1 to 30 wt. %, of polyethylene terephthalate, and 50 to 99 wt. %, preferably 70 to 99 wt. %, of polybutylene terephthalate.

The preferably used polyalkylene terephthalates generally have an intrinsic viscosity of 0.4 to 1.5 dl/g, preferably 0.5 to 1.2 dl/g, measured in phenol/o-dichlorobenzene (1:1 parts by weight) at 25° C. in an Ubbelohde viscosimeter.

The polyalkylene terephthalates can be produced according to methods known perse (see for example Kunststoff-Handbuch, Vol. VIII, p. 695 et seq., Carl-Hanser-Verlag, Munich 1973).

Component D

The compositions according to the invention contain as flame retardant phosphorus compounds represented by general formula (I), as described previously herein.

The suitable phosphorus compounds according to the invention (component D) are generally known (see for example Ullmanns Enzyklopädie der Technischen Chemie, Vol. 18 p.301 et seq. 1979; Houben-Weyl, Methoden der Organischen Chemie, Vol. 12/1, p. 43; Beilstein, Vol. 6, p. 177).

Preferred substituents R¹ to R⁴ include methyl, butyl, octyl, chloroethyl, 2-chloropropyl, 2,3-dibromopropyl, phenyl, cresyl, cumyl, naphthyl, chlorophenyl, bromophenyl, pentachlorophenyl and pentabromophenyl. Methyl, ethyl, butyl, phenyl and naphthyl are particularly preferred.

The aromatic groups, from which each of R¹, R², R³ and R⁴ may be independently selected, may be substituted by halogen and/or C₁ to C₄ alkyl. Particularly preferred aryl radicals are cresyl, phenyl, xylenyl, propylphenyl or butylphenyl, as well as the brominated and chlorinated derivates thereof.

R⁵ and R⁶ denote, independently of one another, preferably methyl or bromine.

Y denotes isopropylidene.

n in the formula (I) may independently of one another be 0 or 1, and n is preferably equal to 1.

q may be 0, 1, 2, 3 or 4, and is preferably 0, 1 or 2.

N may take values from 0.1 to 5, preferably 0.9 to 2.5, in particular 1 to 1.5.

As component D according to the invention there may also be used mixtures of various phosphates. In this case N is an average value. This mixture may also contain monophosphorous compounds different from IPP, such as for example, and preferably, triphenyl phosphate and tricresyl phosphate.

The mean N values may be determined by establishing the composition of the phosphate mixture (molecular weight distribution) by a suitable method (gas chromatography (GC), high pressure liquid chromatography (HPLC), gel permeation chromatography (GPC)), and then calculating therefrom the mean values for N.

An essential feature of the phosphorus compounds represented by general formula (I) that are used according to the invention is that they contain isopropenylphenyl phosphate (IPP) in an amount of less than 1 wt. %, preferably less than 0.5 wt. %, and even more preferably less than 0.2 wt. %, based on the total weight of the phosphorous compound represented by general formula (I). Isopropenylphenyl phosphate (IPP) is formed under specific conditions (e.g., high temperature, long reactor residence time) as a breakdown or co-product in the synthesis of oligophosphates represented by general formula (I). In the production of the phosphorus compounds that can be used according to the invention, according to the aforementioned processes known in the literature, care must therefore be taken to ensure, by maintaining suitable reaction conditions (e.g., relatively low temperatures, short residence time in the reactor, and the use of a suitable catalyst), that the IPP content does not exceed the aforementioned values. Alternatively the isopropenylphenyl phosphate content of the phosphorus compound that is used may be reduced to a value of <1 wt. % by art-recognized purification and/or separation processes (e.g., chromatography or extraction with suitable solvents), before the compound is used as a flame retardant.

Component E

Fluorinated polyolefins may be added as further component.

The fluorinated polyolefins E are high molecular weight compounds and have glass transition temperatures of above −30° C. (e.g., above 100° C.), fluorine contents preferably in the range from 65 to 76 wt. %, in particular 70 to 76 wt. %, and mean particle diameters d₅₀ of 0.05 to 1,000 μm, preferably 0.08 to 20 μm. In general the fluorinated polyolefins E have a density of 1.2 to 2.3 g/cm³. Preferred fluorinated olefins E include polytetrafluoroethylene, polyvinylidene fluoride, tetrafluoroethylene/hexafluoropropylene copolymers and ethylene/tetrafluoroethylene copolymers. The fluorinated polyolefins are known (see “Vinyl and Related Polymers” by Schildknecht, John Wiley & Sons, In., New York, 1962, pp. 484-494; “Fluoropolymers” by Wall, Wiley-Interscience, John Wiley & Sons, Inc., New York, Vol.13,1970, pp. 623-654; “Modern Plastics Encyclopedia”, 1970-1971, Vol. 47, No. 10 A, October 1970, McGraw-Hill, Inc., New York, pp. 134 and 774; “Modern Plastics Encyclopedia”, 1975-1976, October 1975, Vol. 52, No. 10 A, McGraw-Hill, Inc., New York, pp. 27, 28 and 472 and U.S. Pat. No. 3,671,487, U.S. Pat. No. 3,723,373 and U.S. Pat. No. 3,838,092).

The polyolefins E may be produced by methods known per se, for example by polymerisation of tetrafluoroethylene in an aqueous medium using a free radical-forming catalyst, for example sodium, potassium or ammonium peroxodisulfate at pressures of 7 to 71 kg/cm² and at temperatures from 0 to 200° C., preferably at temperatures from 20 to 100° C., for example as described in U.S. Pat. No. 2,393,967. Depending on the form in which they are used, the density of these materials may be between 1.2 and 2.3 g/cm³, and the mean particle size may be between 0.5 and 1,000 μm.

Preferred fluorinated polyolefins E according to the invention include tetrafluoro-ethylene polymers with mean particle diameters of 0.05 to 20 μm, preferably 0.08 to 10 μm, and a density of 1.2 to 1.9 g/cm³, and are preferably used in the form of a coagulated mixture of emulsions of the tetrafluoroethylene polymers E with emulsions of the graft polymers B. Suitable tetrafluoroethylene polymer emulsions are commercially available products and are available for example from DuPont as Teflon®30N.

Suitable fluorinated polyolefins E that may be used in powder form include tetrafluoroethylene polymers with mean particle diameters of 100 to 1,000 μm and densities of 2.0 g/cm³ to 2.3 g/cm³, and are available from DuPont as TEFLON and Dyneon GmbH (Burgkirchen, Germany) under the trade name HOSTAFLON® PTFE.

The compositions according to the invention may contain at least one art-recognized additive, such as lubricants and mould release agents, for example pentaerythritol tetrastearate, nucleating agents, antistatics, stabilisers, fillers and reinforcing agents, as well as dyes and pigments.

The polycarbonate composition according to the invention may furthermore contain 0 to 50 wt. % of a very finely particulate inorganic compound with a mean particle diameter of less than 200 nm. Such very finely particulate inorganic compounds are for example described in U.S. Pat. No. 5,849,827.

The compositions containing fillers and/or reinforcing agents may contain up to 60 wt. %, preferably 10 to 40 wt. %, referred to the filler-containing and/or reinforced composition, of fillers and/or reinforcing agents. Preferred reinforcing agents are glass fibres. Preferred fillers, which may also have a reinforcing action, include glass spheres, mica, silicates, quartz, talcum, titanium dioxide and wollastonite.

The compositions according to the invention may contain up to 35 wt. %, referred to the overall composition, of a further, optionally synergistically acting flame retardant. Further flame retardants that may be mentioned by way of example include organic halogenated compounds such as decabromobisphenyl ether, tetrabromobisphenol, inorganic halogenated compounds such as ammonium bromide, nitrogen compounds such as melamine, melamine-formaldehyde resins, inorganic hydroxide compounds such as Mg hydroxide and Al hydroxide, inorganic compounds such as antimony oxides, barium metaborate, hydroxoantimonate, zirconium oxide, zirconium hydroxide, molybdenum oxide, ammonium molybdate, zinc borate, ammonium borate, barium metaborate, talcum, silicate, silicon dioxide and tin oxide, as well as siloxane compounds. Monophosphate compounds other than IPP, oligomeric phosphate compounds or mixtures thereof may furthermore also be used as flame retardants. Such phosphate compounds are described in EP-A 0 363 608, EP-A 0 345 522 and DE-A 197 21 628.

The compositions according to the invention that contain the components A to E and optionally further known additives such as stabilisers, dyes, pigments, lubricants and mould release agents, nucleating agents as well as antistatics, fillers and reinforcing agents, are typically produced by mixing the relevant constituents in a manner known per se and melt compounding and melt extruding the latter at temperatures of 200° C. to 300° C. in conventional equipment such as internal kneaders, extruders and twin-shaft screw units, the component E preferably being used in the form of the previously mentioned coagulated mixture.

The mixing of the individual constituents may be carried out in a known manner, successively and also simultaneously, and more particularly at about 20° C. (room temperature) as well as at higher temperatures.

On account of their excellent flame resistance, in particular the short afterburning time, and their good mechanical properties and high heat resistance, the thermoplastic compositions according to the invention are suitable for producing all types of mouldings, in particular mouldings that have to satisfy stringent requirements as regards mechanical properties, especially when the compositions are subjected to prolonged thermal stresses.

The compositions of the present invention may be used to produce mouldings of all types. In particular, mouldings can be produced by injection moulding. Examples of mouldings that can be produced include: housing parts of all types, e.g. for domestic appliances such as juice presses, coffee-making machines, mixers, for office equipment such as monitors, printers, copiers or coverplates for the construction sector, as well as parts for the motor industry. The compositions can also be used in the electrical engineering sector, as they have good electrical properties.

Moreover, the compositions according to the invention may be used for example to produce the following mouldings and/or moulded parts: internal dismantleable parts for track-guided vehicles, wheelcaps, housings for electrical equipment containing small transformers, housings for equipment for information propagation and transmission, housings and clothing for medical purposes, massage equipment and housings for the latter, toy vehicles for children, two-dimensional wall elements, housings for safety equipment, rear spoilers, thermally insulated transportation containers, devices for holding or handling small animals, moulded parts for sanitaryware and bathware, cover gratings for ventilation openings, moulded parts for garden sheds and instrument housings, and housings for garden tools.

A further processing application is the production of mouldings by thermoforming from previously produced sheets or films.

The invention will be described in more detail hereinafter with the aid of an example of implementation.

The present invention is more particularly described in the following examples, which are intended to be illustrative only, since numerous modifications and variations therein will be apparent to those skilled in the art. Unless otherwise specified, all parts and percentages are by weight.

### EXAMPLES

Component A

Polycarbonate based on bisphenol A having a relative solution viscosity of 1.255, measured in methylene chloride at 25° C. and in at a concentration of 0.5 g/100 ml.

Component B

Graft polymer composed of: B.1, 40 wt. % of a copolymer of styrene and acrylonitrile in a ratio of 73:27; and B.2, 60 wt. % of particulate crosslinked polybutadiene rubber (mean particle diameter d₅₀=0.34 μm), produced by emulsion polymerisation.

Component C

Styrene/acrylonitrile copolymer with a styrene/acrylonitrile ratio of 72:28 and an intrinsic viscosity of 0.55 dl/g (measured in dimethylformamide at 20° C.).

Component D

A phosphorous compound represented by the following general formula (V),

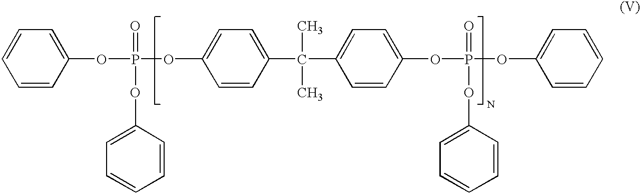

D1 N=1.1; IPP content: 0.1 wt. %

D2 N=1.1; IPP content: 9.0 wt. %

In order to determine the mean N value the proportions of the monomeric and oligomeric phosphates are first of all determined by HPLC measurements;

Column type: LiChrosorp RP-8

Eluant in the gradient:

Acetonitrile/water 50:50 to 100:0

Concentration 5 mg/ml

The numerically weighted mean values are then calculated by known methods from the fractions of the individual components, i.e. monophosphates and oligo-phosphates.

The IPP content of the oligophosphate was also determined by the HPLC measurement method described above.

Component E

Tetrafluoroethylene polymer in the form of a coagulated mixture of a SAN graft polymer emulsion according to component B in water and a tetrafluoroethylene polymer emulsion in water. The weight ratio of graft polymer B to tetrafluoroethylene polymer E in the mixture is 90 wt. % to 10 wt. %. The tetrafluoroethylene polymer emulsion has a solids content of 60 wt. %, and the mean particle diameter is between 0.05 and 0.5 μm. The SAN graft polymer emulsion has a solids content of 34 wt. % and a mean latex particle diameter of 0.34 μm.

In order to prepare the component E the emulsion of the tetrafluoroethylene polymer (Teflon® 30N from DuPont) is mixed with the emulsion of the SAN graft polymer B and stabilised with 1.8 wt. %, referred to polymer solids, of phenolic antioxidants. The mixture is coagulated at 85 to 95° C. with an aqueous solution of MgSO₄ (Epsom salt) and acetic acid at pH 4 to 5, filtered and washed until practically free from electrolyte, then freed from most of the water by centrifugation, and finally dried at 100° C. to form a powder. This powder can then be compounded with the further components in the aforedescribed equipment.

Preparation and testing of the compositions according to the invention The mixing of the components with the conventional processing auxiliary substances takes place in a 3 I capacity internal kneader. The mouldings are produced at 260° C. in a Arburg 270E type injection moulding machine.

The determination of the Vicat B heat resistance is performed according to DIN 53 460 on rods of the following dimensions: 80×10×4 mm.

The determination of the notched bar impact strength aₖ is performed according to ISO 180/1 A.

The flame resistance is determined according to UL 94 V.

In order to determine the yellowing tendency, test bodies having the dimensions 60×40×2 mm (produced at 260° C.) are stored at 100° C. for 24 hours in a circulating air cabinet and are then evaluated visually.

TABLE 1
Compositions

| Components (wt. %) | 1 (Comparison) | 2 |
|---|---|---|
| A | 65.7 | 65.7 |
| B | 7.5 | 7.5 |
| C | 7.5 | 7.5 |
| D1 (IPP 0.1%) | — | 13.0 |
| D2 (IPP 9.0%) | 13.0 | — |
| E | 5.0 | 5.0 |
| Mould release agent (PETS)* | 0.4 | 0.4 |

*PETS-pentaerythritol tetrastearate

TABLE 2
Physical Properties

| Properties | 1 (Comparison) | 2 |
|---|---|---|
| aₖ (kJ/m²) | 39 | 45 |
| Notched bar impact strength | | |
| Vicat B 120 (° C.) | 99 | 102 |
| Heat resistance | | |
| UL 94 V 1.6 mm | V-1 | V-0 |
| Flame resistance | | |
| Overall burning time (sec.) | 60 | 35 |
| Tendency to yellowing under heat ageing | − | + |

+ = no changes after heat ageing
− = significant yellowing after heat ageing

From the physical properties summarized in Table 2 it is evident that composition 2 according to the invention with a IPP content of 0.1 wt. %, based on the total weight of phosphorous compound D1, has a significantly improved notched bar impact strength (aₖ), an improved heat resistance (Vicat B), a shorter afterburning time (UL-94) as well as a lesser tendency to yellowing during heat ageing, than the composition of comparison example 1 with an IPP content of 9 wt. %, based on the total weight of phosphorous compound D2.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polycarbonate composition comprising a phosphorus compound represented by the general formula (I), 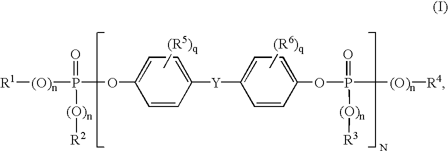
in which
R¹, R², R³ and R⁴ are each independently selected from (i) C₁ to C₈ alkyl optionally substituted by halogen, (ii) C₅ to C₆ cycloalkyl, (iii) C₆ to C₁₀ aryl and (iv) C₇ to C₁₂ aralkyl, each of (ii), (iii) and (iv) being optionally and independently substituted by at least one of halogen and C₁ to C₄ alkyl;
n is 0 or 1;
q is 0, 1, 2, 3 or 4;
N is 0.1 to 5
R⁵ and R⁶ are each independently selected from C₁ to C₄ alkyl and halogen; and
Y denotes isopropylidene,
wherein the phosphorous compound represented by general formula (I) comprises less than 1 wt. % of isopropenylphenyl phosphate, based on the weight of said phosphorus compound represented by formula (I).

2. The composition of claim 1, wherein said phosphorous compound represented by general formula (I) comprises less than 0.5 wt. % of isopropylphenyl phosphate, based on the weight of said phosphorus compound represented by general formula (I).

3. The composition of claim 1, wherein said phosphorous compound represented by general formula (I) comprises less than 0.2 wt. % of isopropylphenyl phosphate, based on the weight of said phosphorus compound represented by general formula (I).

4. The composition of claim 1, comprising 0.5 to 20 wt. % of said phosphorus compound represented by general formula (I) or a mixture of phosphorus compounds represented by general formula (I), based on the total weight of said composition.

5. The composition of claim 1, further comprising 0.5 to 60 wt. % of a graft polymer, based on the total weight of said composition.

6. The composition of claim 1, wherein said composition comprises:
A) 40 to 99 wt. % of at least one of aromatic polycarbonate and polyester carbonate;
B) 0.5 to 60 wt. % of a graft polymer;
C) 0 to 45 wt. % of at least one thermoplastic polymer selected from the group comprising of vinyl (co)polymers and polyalkylene terephthalates;
D) 0.5 to 20 wt. % of said phosphorus compound represented by general formula (I); and
E) 0 to 5 wt. % of a fluorinated polyolefin,
wherein the weight percents of A), B), C), D) and E) are each based on the total weight of said composition.

7. The composition of claim 6 wherein said graft polymer B) is prepared from:
B.1 5 to 95 wt. % of at least one vinyl monomer; and
B.2 95 to 5 wt. % of at least one graft base having a glass transition temperature of less than 10° C., the weight percents of B.1 and B.2 being based on the total weight of B.1 and B.2.

8. The composition of claim 7, wherein
said vinyl monomer B.1 comprises a mixture of,
B.1.1 a first vinyl monomer selected from at least one of styrene, α-methyl styrene, p-methyl styrene, p-chlorine styrene and (meth) acrylic acid-(C₁-C₈)-alkyl esters, and
B.1.2 a second vinyl monomer selected from at least one of vinyl cyanides, (meth)acrylic acid-(C₁-C₈)-alkyl esters and derivatives of unsaturated carboxylic acids; and
said graft base B.2 is selected from diene rubber, acrylate rubber, EP(D)M rubber and mixtures thereof.

9. The composition of claim 8 wherein
said first vinyl monomer B.1.1 is styrene and said second vinyl monomer B.1.2 is acrylonitrile; and
said graft base B.2 is polybutadiene, the polybutadiene optionally comprising up to 30 wt. %, based on the weight of said graft base B.2, of a comonomer selected from styrene, acrylonitrile, methylmethacrylate and mixtures thereof.

10. The composition of claim 1, further comprising at least one additive selected from stabilisers, pigments, mould release agents, flow auxiliary substances, antistatics, fillers and reinforcing agents.

11. A moulded article prepared from the composition of claim 1.

12. A method of improving the flame resistance of a composition comprising a thermoplastic polymer selected from at least one of polycarbonate and polyester carbonate, said method comprising incorporating into said composition a phosphorus compound represented by general formula (I), 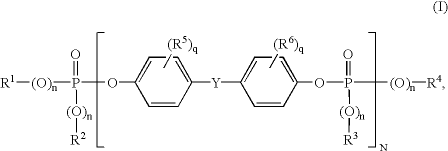
in which
R¹, R², R³ and R⁴ are each independently selected from (i) C₁ to C₈ alkyl optionally substituted by halogen, (ii) C₅ to C₆ cycloalkyl, (iii) C₆ to C₁₀ aryl and (iv) C₇ to C₁₂ aralkyl, each of (ii), (iii) and (iv) being optionally and independently substituted by at least one of halogen and C₁ to C₄ alkyl;
n is 0 or 1;
q is 0, 1, 2, 3 or 4;
N is 0.1 to 5
R⁵ and R⁶ independently of one another are each selected from C₁ to C₄ alkyl and halogen; and
Y denotes isopropylidene,
wherein the phosphorous compound represented by general formula (I) comprises less than 1 wt. % of isopropenylphenyl phosphate, based on the weight of the phosphorous compound represented by general formula (I).

13. The method of claim 12, wherein the phosphorus compound represented by general formula (I) comprises less than 0.5 wt. % of isopropenylphenyl phosphate, based on the weight of said phosphorous compound represented by formula (I).

14. The method of claim 12, wherein the phosphorus compound represented by general formula (I) comprises less than 0.2 wt. % of isopropenylphenyl phosphate based on the weight of said phosphorus compound represented by general formula (I).

15. The composition of claim 7 wherein said graft base B.2 has a glass transition temperature of less than 0° C.

16. The composition of claim 7 wherein said graft base B.2 has a glass transition temperature of less than −20° C.

17. The composition of claim 8 wherein the vinyl cyanides, of which said second vinyl monomer B.1.2 may be selected, are selected from at least one of acrylonitrile and methacrylonitrile; and the derivatives of unsaturated carboxylic acids, of which said second vinyl monomer B.1.2 may be selected, are selected from at least one of maleic acid anhydride and N-phenylmaleimide.
